(19) United States
(12) Patent Application Publication
(10) Pub. No.: US 2026/0319791 A1
(43) Pub. Date: Oct. 15, 2026

(54) Systems and Methods for Generating a Software Bill of Materials

(71) Applicant: Dispel, LLC, Austin, TX (US)

(72) Inventor: Ian Michael Schmertzler, Austin, TX (US)

(21) Appl. No.: 19/536,524

(22) Filed: Feb. 11, 2026

Related U.S. Application Data
(60) Provisional application No. 63/757,968, filed on Feb. 13, 2025.

(51) Int. Cl. G06F 8/75; G06F 8/61

(52) U.S. Cl. CPC G06F 8/75; G06F 8/61

(57) ABSTRACT

Systems and methods are provided for a computer network. The computer network includes a network implementation engine having credentials for accessing a provider. The network implementation engine is configured to receive an initiation directive from a first user and, based on the initiation directive, generate an instruction for the provider. The computer network further includes a microservice instance generated by the provider based on the instruction. The microservice instance is configured to receive a software program, apply a query script to the software program, and to extract information from the software program based on the query script.

### CROSS-REFERENCE TO RELATED APPLICATIONS

This application claims priority to U.S. Provisional Application No. 63/757,968, filed Feb. 13, 2025, which is incorporated herein by reference in its entirety.

### FIELD

This disclosure is related generally to software bill of materials (SBOMs), and more particularly to computer networks for generating SBOMs.

### BACKGROUND

Software programs perform a variety of tasks and functions within a computing environment. Many modern software programs include various sub-programs that perform a variety of differing functions. Such sub-programs often include one or more dependencies on other sub-programs within the software program. Moreover, sub-programs often include a hierarchical relationship with respect to one another. A software bill of materials (SBOM) is an inventory of software components (e.g., subsystems) and information about those components, which can include dependencies of the components and hierarchical relationships of those components. In some examples, an SBOM is provided in a standardized machine-readable format. An SBOM may include information sufficient for performing a supply chain check on a software program to be installed in a shared ownership computing environment. For example, an SBOM can provide information to ensure a software program is compatible with other programs in an environment.

In some environments, a first user (e.g., a customer) owns or operates a piece of hardware or equipment that may require the installation of a software program or to receive commands from a software program. A second user (e.g., a vendor) may wish to install a software program on the hardware or equipment of the first user. Moreover, a second user may wish to run a software program on a dataset managed by a second user in order to perform a service or task. In such environments, the first user may wish to ensure that the software to be installed does not interfere with other equipment or software programs within the shared environment. For example, a customer may own a factory containing one or more pieces of equipment that are used to manufacture a particular item. A vendor may wish to install a software program on the equipment or control the equipment for a variety of reasons, including operational or diagnostic purposes. In such examples, the customer may wish to take sufficient precautionary measures to ensure that the software of the vendor is compatible with other software installed on the equipment or within the factory.

An SBOM may be an effective method for such precautions. However, a user installing software within a shared environment may be reluctant to provide the SBOM of the software program directly to another user of the shared environment. For example, the software program may be proprietary, or the generation of the SBOM may be costly or inconvenient for a user. But obtaining the SBOM may be critical to ensuring compatibility with existing systems and may be a necessary procedural or regulatory requirement of a user of the shared environment. Hence, obtaining an SBOM can be difficult and cumbersome in some environments.

### SUMMARY

Systems and methods are provided for a computer network. The computer network includes a network implementation engine having credentials for accessing a provider. The network implementation engine is configured to receive an initiation directive from a first user and, based on the initiation directive, generate an instruction for the provider. The computer network further includes a microservice instance generated by the provider based on the instruction. The microservice instance is configured to receive a software program, apply a query script to the software program, and extract information from the computer program based on the query script.

As another example, a computer network initiated by a first user is accessible by the first user and a second user. The computer network is configured to receive a software program from the second user. A query script is applied to the software program. Based on the query script, information is extracted from the software program.

As another example, a method includes receiving an initiation directive from a first user. Based on the initiation directive, a provider is instructed to generate a microservice instance that is accessible by a second user. A software program is received from the second user at the microservice instance. A query script is applied to the software program. Based on the query script, information is extracted from the software program.

### DESCRIPTION OF DRAWINGS

FIG. 1 is a diagram depicting an SBOM generation network, in accordance with some embodiments.

FIG. 2 is a diagram depicting a network implementation engine receiving an initiation directive, in accordance with some embodiments.

FIG. 3 is a diagram depicting a network implementation engine directing a provider to deploy a microservice instance, in accordance with some embodiments.

FIG. 4 is a diagram depicting a second user sending a software program to a microservice instance, in accordance with some embodiments.

FIG. 5 is a diagram depicting a microservice instance generating an SBOM, in accordance with some embodiments.

FIG. 6 is a diagram depicting a provider deleting a microservice instance, in accordance with some embodiments.

FIG. 7 is a diagram depicting a user interface for generating an SBOM, in accordance with some embodiments.

FIG. 8 is a diagram depicting a method performed by a computer network, in accordance with some embodiments.

FIG. 9 is a diagram depicting a method, in accordance with some embodiments.

### DETAILED DESCRIPTION

As noted above, some systems and methods for generating a software bill of materials (SBOM) present difficulties for users of a shared environment. For example, in some environments, a user may be reluctant to provide an SBOM to another user, perhaps based on inconvenience or privacy concerns. But obtaining an SBOM of a software program may be critical for some users. For example, an SBOM may be necessary for obtaining important information regarding a software program, such as attributes and dependencies of particular sub-systems within the program. Additionally, obtaining an SBOM may be a regulatory or procedural requirement of a particular process.

Example systems and methods disclosed herein provide solutions for securely creating a computer network (e.g., a managed attribution network or encrypted network) through which a user of a shared environment (e.g., a vendor) is able to access equipment or data of another user. Furthermore, systems and methods disclosed herein include points of presence within the network that are capable of receiving a software program and generating an SBOM for that program. These points of presence may be generated by a user (e.g., a customer) having sufficient management and/or control of the shared environment. Systems and method disclosed herein can thus ensure the generation of an SBOM, which may be critical to some users, while also obviating concerns of users supplying a software program.

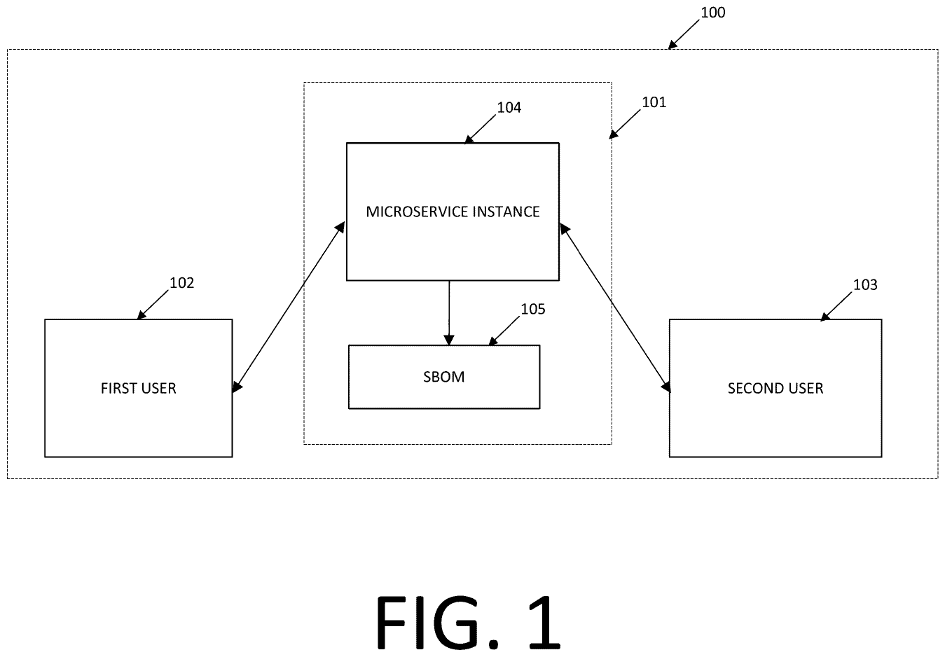

FIG. 1 is a diagram depicting an SBOM generation network, in accordance with some embodiments. The SBOM generation network 100 includes a first user 102 and a second user 103. The first user 102 may be, for example, a customer of a service. For example, the first user 102 may purchase software programs. The software programs may be used, for example, to perform functions for commercial operations of the first user 102. In some examples, the first user 102 may be a purchaser of software programs that are installed on equipment belonging to the first user 102. The second user 103 may be a vendor providing a software program. For example, the second user 103 may be a vendor seeking to install the software program on a piece of hardware or equipment at a factory of the first user 102 or send commands to the equipment via the software program. Furthermore, the second user 103 may wish to apply the software program to a dataset of the first user 102 as part of a service.

The SBOM generation network 100 further includes a computer network 101. The computer network 101 may be, for example, a managed attribution network or an encrypted network (e.g., a Software-Defined Wide Area Network (SD-WAN) or a secure enclave). The computer network 101 may be remotely accessible. The computer network 101 includes a microservice instance 104. The computer network 101 may be initiated, for example, by the first user 102 (e.g., the customer). The second user 103 may be able to access equipment or hardware of the first user 102 via the computer network 101.

The microservice instance 104 of the computer network 101 receives a software program from the second user 103. Based on the software program received from the second user 103, the microservice instance 104 generates an SBOM 105. As described above, the SBOM 105 may include information such as dependencies and hierarchies of particular sub-systems within the program. The SBOM 105 may be accessible and reviewable by the first user 102. The first user 102 may wish to obtain the SBOM 105, for example, to run a supply chain check on the computer program. Additionally, the SBOM 105 may be required under an applicable regulation or policy of the first user 102.

The microservice instance 104 may be further configured to install the software program received by the second user on equipment owned or operated by the first user 102. In some examples, the software program remains on the microservice instance 104 and is used to send commands to the equipment of the first user 102 based on user input. Furthermore, in some examples the microservice instance 104 is configured to apply the software program to a dataset of the first user 102. The software program may be installed on the equipment, used to control the equipment, or applied to the dataset based on the SBOM 105. For example, the SBOM 105 may be installed or applied to a dataset only after the first user 102 is satisfied that the SBOM 105 is compatible with its systems or equipment.

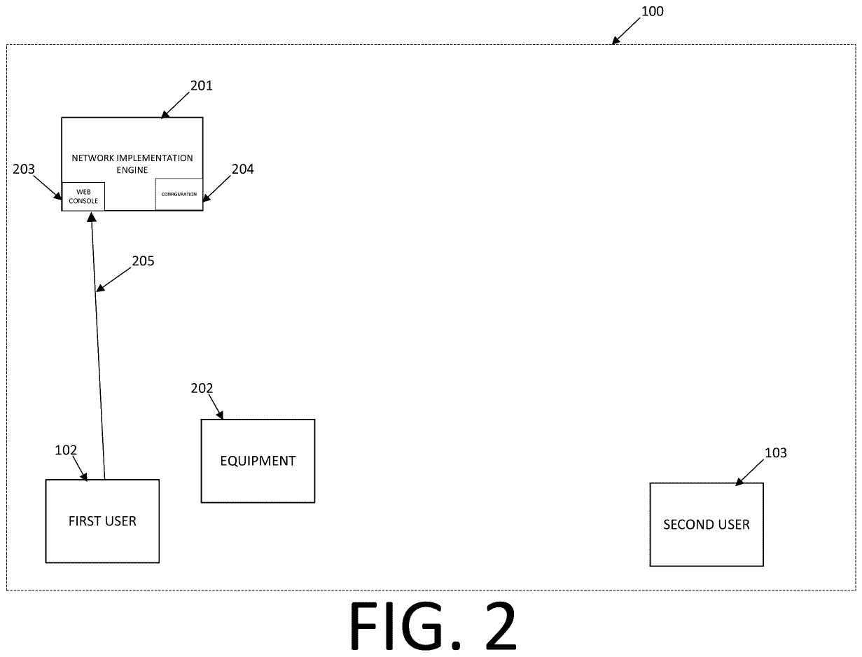

FIG. 2 is a diagram depicting a network implementation engine receiving an initiation directive, in accordance with some embodiments. In the example shown in FIG. 2, the SBOM generation network 100 includes a network implementation engine 201. The network implementation engine 201 may include features described in U.S. Pat. No. 10,284,633, which is hereby incorporated by reference in its entirety. The network implementation engine 201 includes a configuration 204. The configuration 204 may include credentials sufficient for directing one or more providers (e.g., Platform-as-a-Service (PaaS) providers) to instantiate a microservice instance 104 (FIG. 1). Furthermore, the network implementation engine 201 may include a web console 203. The SBOM generation network 100 may further include equipment 202. The equipment 202 may be, for example, hardware installed at a factory or location owned or operated by the first user 102. In some examples, the SBOM generation network 100 includes a dataset of the first user 102 rather than the equipment 202.

The first user 102 enters the initiation directive 205 at the web console 203 of the network implementation engine 201. As described above, the first user 102 may be a customer within the SBOM generation network 100. Furthermore, in some examples the first user 102 may be an administrator having sufficient authority within the SBOM generation network 100 for facilitating the generation of the microservice instance 104.

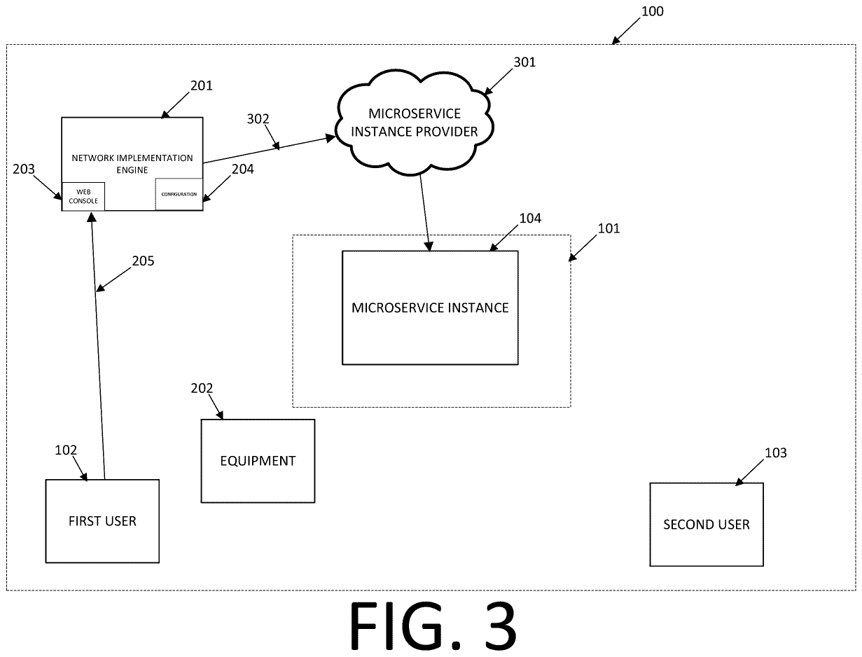

FIG. 3 is a diagram depicting a network implementation engine directing a provider to deploy a microservice instance, in accordance with some embodiments. Based on the initiation directive 205, the network implementation engine 201 generates an instruction 302. The network implementation engine 201 utilizes the credentials within its configuration 204 to generate the instruction 302. The instruction 302 is received by a microservice instance provider 301. Based on the instruction 302, the microservice instance provider 301 instantiates a microservice instance 104. As described above, the microservice instance 104 may be a part of a computer network 101 such as a managed attribution network or an encrypted network.

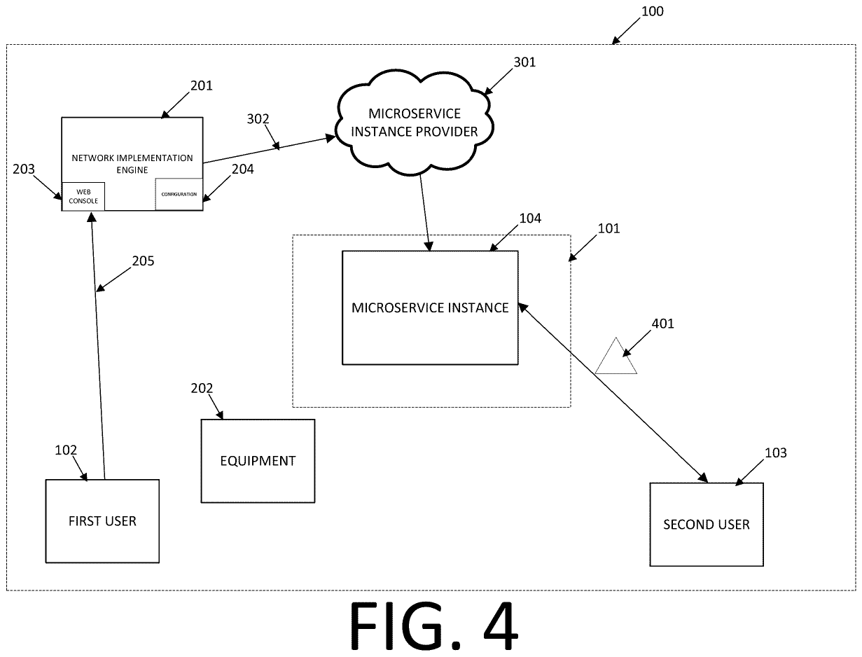

FIG. 4 is a diagram depicting a second user sending a software program to a microservice instance, in accordance with some embodiments. The second user 103 sends (e.g., uploads) the software program 401 to the microservice instance 104. The second user 103 may access the microservice instance 104, for example, via an address (e.g., URL address) of the microservice instance 104. Additionally, the second user 103 may be required to enter credentials (e.g., a username and password) to access the microservice instance 104. The second user 103 may have received the address and credentials, for example, from the first user 102. The software program 401 may be sent to the microservice instance 104 via a browser operated by the second user 103.

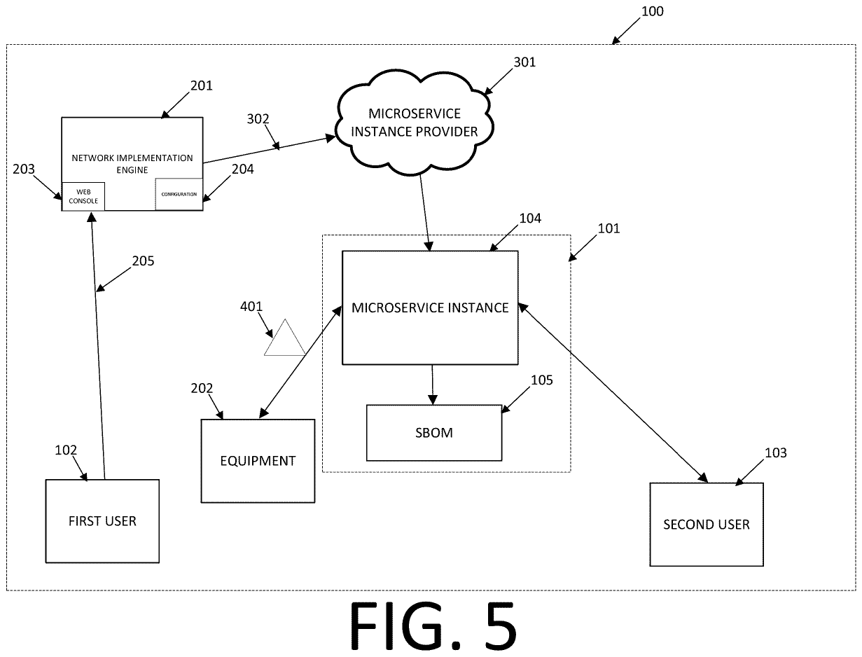

FIG. 5 is a diagram depicting a microservice instance generating an SBOM, in accordance with some embodiments. The microservice instance 104 is configured to run an SBOM query script on the software program 401. Based on the SBOM query script, the microservice instance 104 generates the SBOM 105. The SBOM 105 may include an inventory of components and sub-programs of the software program 401. Furthermore, the SBOM 105 may include information about the components and sub-programs, as well as information about their hierarchical relationship and dependencies of the sub-programs.

The microservice instance 104 may then install the software program 401 on the equipment 202. The equipment 202 may be located, for example, at a factory or building owned or operated by the first user 102. In some examples, the software program 401 is not installed on the equipment 202 but is used to send commands to the equipment 202 from the microservice instance 104 or is applied to a dataset. The dataset may include information regarding parameters that are relevant to the first user (e.g., commercial, financial, or logistical information). As described above with respect to FIG. 1, the software program 401 may be installed or applied to the dataset only after the first user 102 is satisfied that the SBOM 105 is compatible with its systems or equipment. This process of assessing the SBOM 105 may be automated (e.g., via a separate program installed on the microservice instance 104 or elsewhere within the SBOM generation network 100), or may be performed by the first user 102 without automation. After the SBOM 105 is generated, the SBOM may be retained by the first user 102 and stored on a permanent data storage device.

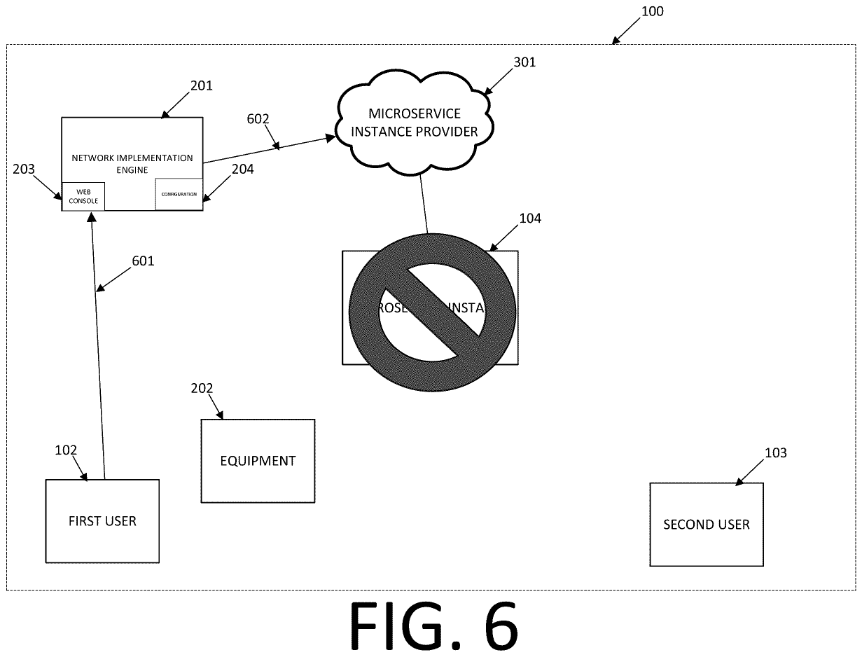

FIG. 6 is a diagram depicting a provider deleting a microservice instance, in accordance with some embodiments. In the example shown in FIG. 6, the first user 102 generates a termination directive 601. The termination directive 601 may be entered at the web console 203 of the network implementation engine 201. The termination directive 601 may be entered, for example, after the SBOM 105 (FIG. 5) is generated and after the second user 103 performs any services with the software program 401 (FIG. 4). Based on the termination directive 601, the network implementation engine 201 generates an instruction 602 instructing the microservice instance provider 301 to delete the microservice instance 104. The network implementation engine 201 may utilize credentials within its configuration 204 to access the microservice provider 301. Based on the instruction 602, the microservice instance provider 301 terminates and deletes the microservice instance 104.

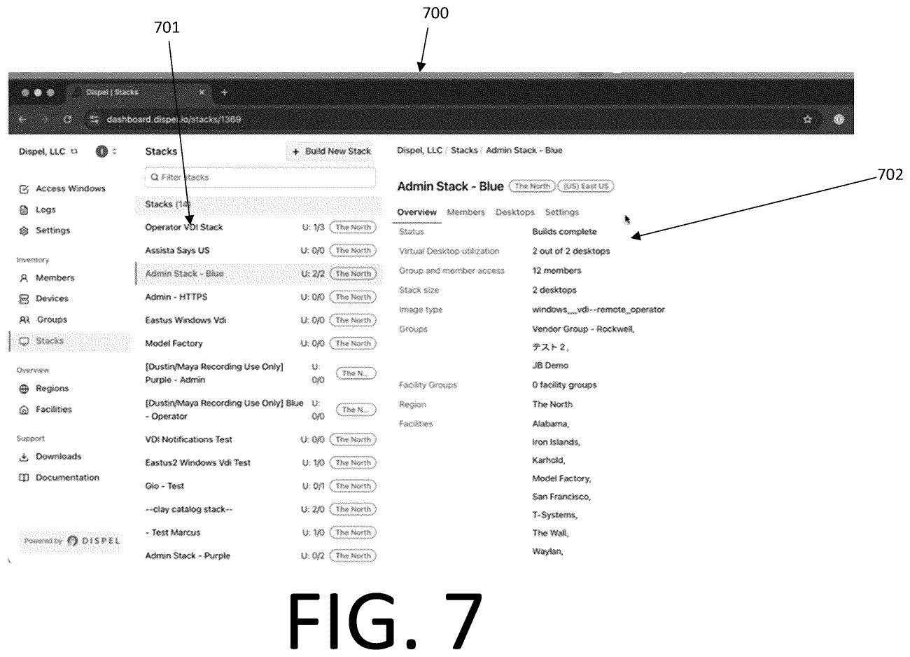

FIG. 7 is a diagram depicting a user interface for generating an SBOM, in accordance with some embodiments. The user interface 700 depicted in FIG. 7 may appear, for example, on a browser operated by the first user 102 and accessing the microservice instance 104 (FIG. 5). The user interface 700 includes buttons corresponding to a plurality of differing software programs. The software programs may be, for example, the software programs 401 received by the microservice instance 104. A user interacting with the user interface 700 may select (e.g., via the buttons) one or more of the plurality of software programs. The user interface 700 then displays an SBOM 702 corresponding to the one or more selected software programs. As described above, the SBOM 702 may include various information concerning the selected software program 701. In some examples, the user interface 700 may appear on a software application installed on a device (e.g., a device of the first user 102) and may not appear within a browser.

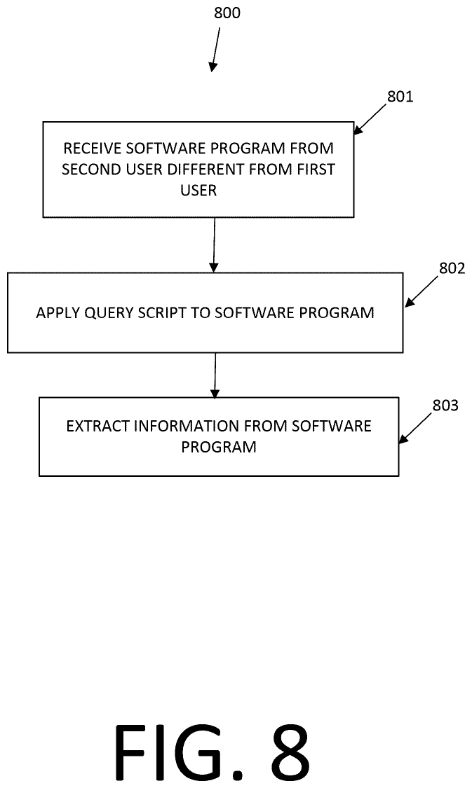

FIG. 8 is a diagram depicting a method performed by a computer network, in accordance with some embodiments. The computer network may have been initiated by a first user. The method 800 includes a first step 801 of receiving a software program from a second user different from the first user. At 802, a query script is applied to the software program. At 803, information is extracted from the software program.

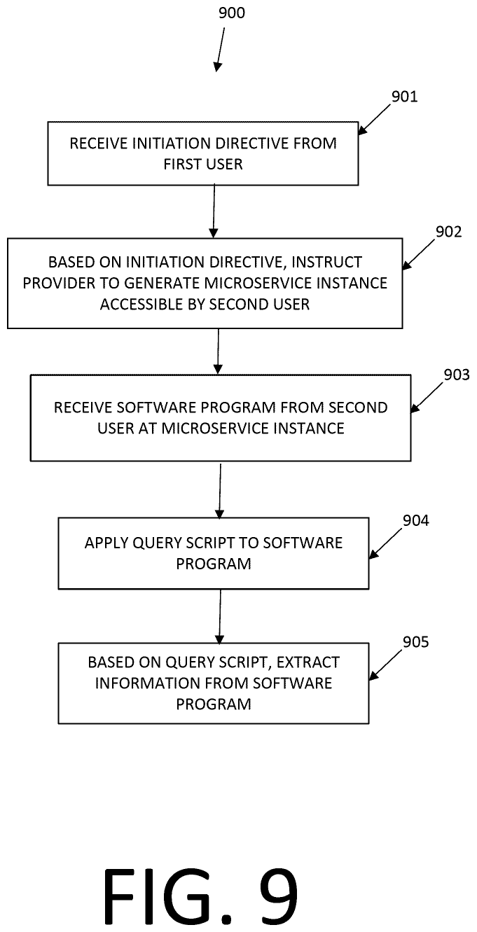

FIG. 9 is a diagram depicting a method, in accordance with some embodiments. The method 900 includes a first step 901 of receiving an initiation directive from a first user. At 902, a provider is instructed to generate a microservice instance that is accessible by a second user based on the initiation directive. At 903, a software program is received from the second user at the microservice instance. At 904, a query script is applied to the software program. At 905, information is extracted from the software program based on the query script.

The methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein and may be provided in any suitable language such as C, C++, JAVA, for example, or any other suitable programming language. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

While the disclosure has been described in detail and with reference to specific embodiments thereof, it will be apparent to one skilled in the art that various changes and modifications can be made therein without departing from the spirit and scope of the embodiments. Thus, it is intended that the present disclosure cover the modifications and variations of this disclosure provided they come within the scope of the appended claims and their equivalents.

It is claimed:

1. A computer network comprising:
a network implementation engine having credentials for accessing a provider, the network implementation configured to receive an initiation directive from a first user and, based on the initiation directive, generate an instruction for the provider; and
a microservice instance generated by the provider based on the instruction, the microservice instance configured to receive a software program, apply a query script to the software program, and to extract information from the software program based on the query script.

2. The computer network of claim 1, wherein the query script is a software bill of materials (SBOM) query script and the microservice instance is further configured to generate an SBOM based on the extracted information.

3. The computer network of claim 1, wherein the microservice instance is further configured to install the software program on a device of the first user.

4. The computer network of claim 1, wherein the microservice instance is further configured to apply the SBOM to a dataset.

5. The computer network of claim 1, wherein the software program installed on the microservice instance is configured to send commands to a device based on user input.

6. The computer network of claim 1, wherein the network implementation engine is further configured to receive a termination directive and to instruct the provider to delete the microservice instance based on the termination directive.

7. A computer network initiated by a first user, the computer network accessible by the first user and a second user and configured to:
receive a software program from the second user;
apply a query script to the software program; and
extract information from the software program.

8. The computer network of claim 7, the computer network further configured to install the software program on a device.

9. The computer network of claim 7, the computer network further configured to apply the software program to a dataset.

10. The computer network of claim 7, wherein the computer network includes a microservice instance accessible by the second user.

11. The computer network of claim 10, wherein the microservice instance is accessible by the second user based on an address of the microservice instance.

12. The computer network of claim 7, wherein the computer network is a managed attribution network.

13. The computer network of claim 7, wherein the computer network is an encrypted network.

14. A method comprising:
receiving an initiation directive from a first user;
based on the initiation directive, instructing a provider to generate a microservice instance accessible by a second user;
receiving a software program from a second user at the microservice instance;
applying a query script to the software program; and
based on the query script, extracting information from the software program.

15. The method of claim 14, wherein the query script is a software bill of materials (SBOM) query script.

16. The method of claim 14, further comprising sending the software program to a device.

17. The method of claim 16, further comprising applying the software program to a dataset.

18. The method of claim 14, further comprising sending commands to a device with the software program.

19. The method of claim 14, further comprising receiving a termination directive and instructing the provider to terminate the microservice instance based on the termination directive.

20. The method of claim 14, further comprising sending an address of the microservice instance to the second user.
